(19) United States
(12) Patent Application Publication
(10) Pub. No.: US 2025/0222485 A1
(43) Pub. Date: Jul. 10, 2025

(54) ADHESIVE APPLICATION SYSTEM

(71) Applicant: HONDA MOTOR CO., LTD., Tokyo (JP)

(72) Inventor: Ryotaro YAMAGAMI, Saitama (JP)

(21) Appl. No.: 19/006,238

(22) Filed: Dec. 31, 2024

(30) Foreign Application Priority Data
Jan. 10, 2024 (JP) 2024-001650

(51) Int. Cl. B05C 5/02; H01M 8/0297

(52) U.S. Cl. CPC B05C 5/0225; H01M 8/0297

(57) ABSTRACT

An adhesive application system applies an adhesive to an intermediate layer at a stage of manufacturing a fuel cell including the intermediate layer and gas diffusion layers on both sides thereof. The adhesive application system includes an applier, a robot arm, and a controller. The applier applies the adhesive when a valve is opened. The robot arm is capable of moving the applier. The controller controls the valve and the robot arm. The controller opens the valve before the applier reaches a position immediately above an application start point while moving the applier by the robot arm, thereby applying the adhesive in the form of a line to the intermediate layer from the application start point.

This application is based on and claims the benefit of priority from Japanese Patent Application No. 2024-001650, filed on 10 Jan. 2024, the content of which is incorporated herein by reference.

### BACKGROUND OF THE INVENTION

### Field of the Invention

The present invention relates to a system for applying an adhesive to a member forming a fuel cell.

### Related Art

Some fuel cells include, in this order from one side, an anode-side gas diffusion layer, an intermediate layer, and a cathode-side gas diffusion layer. Such fuel cells generate power when fuel gas which is gas containing hydrogen is applied to the anode-side gas diffusion layer and oxidation gas which is gas containing oxygen is supplied to the cathode-side gas diffusion layer.
Patent Document 1: Japanese Unexamined Patent Application, Publication No. 2023-161181

### SUMMARY OF THE INVENTION

The present inventor(s) has focused on a point that there are the following problems at a stage of manufacturing the fuel cell. Some fuel cells have a structure in which one gas diffusion layer can be joined to the intermediate layer by thermal pressing, but the other gas diffusion layer cannot be joined to the intermediate layer by thermal pressing. In this case, the other gas diffusion layer needs to be bonded to the intermediate layer with an adhesive.

Specifically, for example, the adhesive is applied in the form of a line to the intermediate layer, and then, the gas diffusion layer is bonded to the intermediate layer. However, in some cases, regions on both sides of a region where the adhesive is applied in the form of a line are adhesive inapplicable regions. Note that the adhesive inapplicable regions described here include, for example, an electrode region and the vicinity of a seal region in the fuel cell.

Specifically, for example, in a case where the adhesive spreads to the electrode region, the adhesive may adversely influence, for example, the internal resistance of the fuel cell. Moreover, for example, in a case where the adhesive spreads to the vicinity of the seal region, the adhesive may adversely influence the sealability of the fuel cell.

Due to the above-described reasons, the region where the adhesive is applied needs to be controlled with high accuracy.

The present invention has been made in view of the above-described situation, and an object thereof is to reduce spread of an adhesive from a desired application region when a gas diffusion layer is bonded to an intermediate layer at a stage of manufacturing a fuel cell.

The present inventor(s) has found that the above-described object can be accomplished when predetermined control is performed on a valve of an applier that applies an adhesive and a robot arm that moves the applier, and has arrived at the present invention. The present invention is an adhesive application system according to (1) to (4) below.
(1) An adhesive application system for applying an adhesive to an intermediate layer at a stage of manufacturing a fuel cell including the intermediate layer and gas diffusion layers on both sides thereof includes
   an applier that applies the adhesive when a valve is opened,
   a robot arm capable of moving the applier, and
   a controller that controls the valve and the robot arm, in which
   the controller opens the valve before the applier reaches a position immediately above an application start point while moving the applier by the robot arm, thereby applying the adhesive in the form of a line to the intermediate layer from the application start point.

According to the present configuration, the valve is opened before the applier reaches the position immediately above the application start point while the applier is moving. Thus, as compared to a case where the valve is opened in a state of the applier being stopped at the position immediately above the application start point and the applier 51 linearly moved when application of the adhesive starts, a liquid accumulation at the application start point can be reduced. Consequently, when the gas diffusion layer is bonded to the intermediate layer, spread of the adhesive from a desired application region can be reduced.
(2) In the adhesive application system according to (1), the controller intermittently opens the valve, thereby applying the adhesive in the form of a dashed line, which is a discontinuous form of the line, to the intermediate layer.

In a case where the adhesive is applied in the form of a solid line, there is a limitation on reduction in an application width. On this point, according to the present configuration, since the adhesive is applied in the form of a dashed line to the intermediate layer, the width of the applied adhesive is easily reduced. Thus, when the gas diffusion layer is bonded to the intermediate layer, spread of the adhesive from the desired application region can be reduced.
(3) An adhesive application system for applying an adhesive to an intermediate layer at a stage of manufacturing a fuel cell including the intermediate layer and gas diffusion layers on both sides thereof includes
   an applier that applies the adhesive when a valve is opened,
   a robot arm capable of moving the applier, and
   a controller that controls the valve and the robot arm, in which
   the controller moves the applier by the robot arm and intermittently opens the valve, thereby applying the adhesive in the form of a dashed line to the intermediate layer.

As in the case of (2), according to the present configuration, the width of the applied adhesive is easily reduced. Thus, when the gas diffusion layer is bonded to the intermediate layer, spread of the adhesive from the desired application region can be reduced.
(4) In the adhesive application system according to any one of (1) to (3),
   the intermediate layer includes an electrolyte membrane and a resin film provided around the electrolyte membrane,
   the adhesive is a moisture-curing adhesive, and
   the controller applies the adhesive to the resin film.

The resin film is less likely to absorb moisture, and on the other hand, the gas diffusion layer easily absorbs moisture. Thus, in the present configuration, the adhesive is less likely to be cured at the point when the moisture-curing adhesive is applied to the resin film. Thereafter, the adhesive is easily cured with moisture in the gas diffusion layer at the point when the gas diffusion layer contacts the adhesive. Thus, the gas diffusion layer is easily properly bonded to the intermediate layer. Consequently, the total amount of adhesive to be applied is easily reduced, and the width of the applied adhesive is easily reduced. As a result, when the gas diffusion layer is bonded to the intermediate layer, spread of the adhesive from the desired application region can be reduced.

As described above, according to the configuration of (1) or (3), when the gas diffusion layer is bonded to the intermediate layer at the fuel cell manufacturing stage, spread of the adhesive from the desired application region can be reduced. Further, according to the configurations (2) and (4) citing (1) or (3), additional effects are obtained.

### BRIEF DESCRIPTION OF THE DRAWINGS

FIG. 1 is a schematic view showing an adhesive application system of a first embodiment;

FIG. 2 is a plan view showing an adhesive of a comparative example;

FIG. 3 is a view showing the flow of operation when an adhesive is applied in the form of a solid line;

FIG. 4 is a side sectional view showing an internal structure of a fuel cell, and is specifically a view showing a section taken along fg4-fg4 line in FIG. 6;

FIG. 5 is a plan view showing a state of the adhesive being applied in the form of a solid line to an intermediate layer of the fuel cell;

FIG. 6 is a plan view showing a state of a gas diffusion layer being bonded to the intermediate layer of the fuel cell; and

FIG. 7 is a view showing the flow of operation when an adhesive is applied in the form of a dashed line in a second embodiment.

### DETAILED DESCRIPTION OF THE INVENTION

Hereinafter, embodiments of the present invention will be described with reference to the drawings. Note that the present invention is not limited to the embodiments below and changes can be arbitrarily made without departing from the gist of the present invention.

### First Embodiment

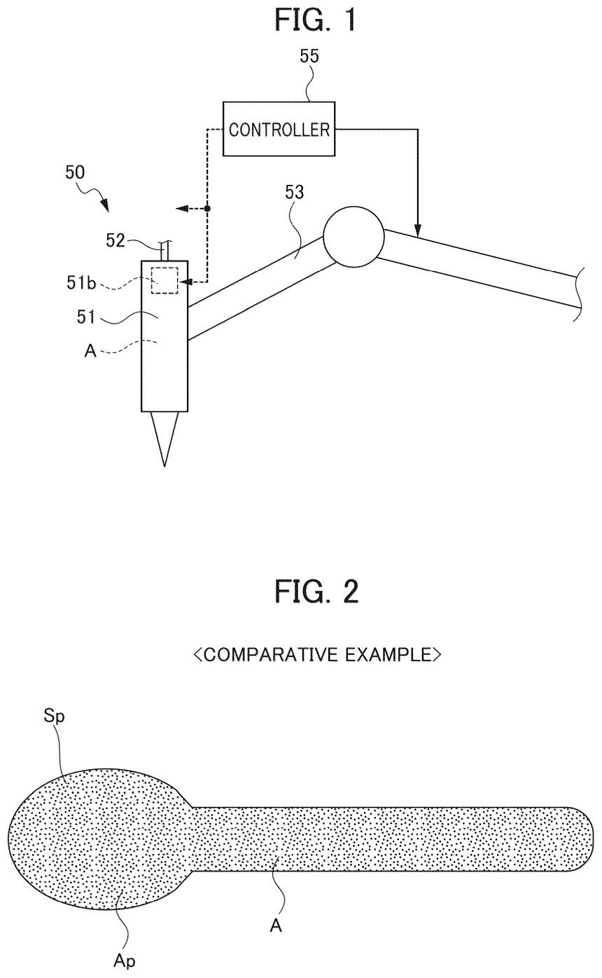

An adhesive application system 50 shown in FIG. 1 is a device for manufacturing a fuel cell 40 shown in FIG. 4. The fuel cell 40 includes, in this order from one side, an anode-side gas diffusion layer 20a, an intermediate layer 30, and a cathode-side gas diffusion layer 20c. Note that the intermediate layer 30 may be read as a “UEA” or a “utilized electrode assembly”.

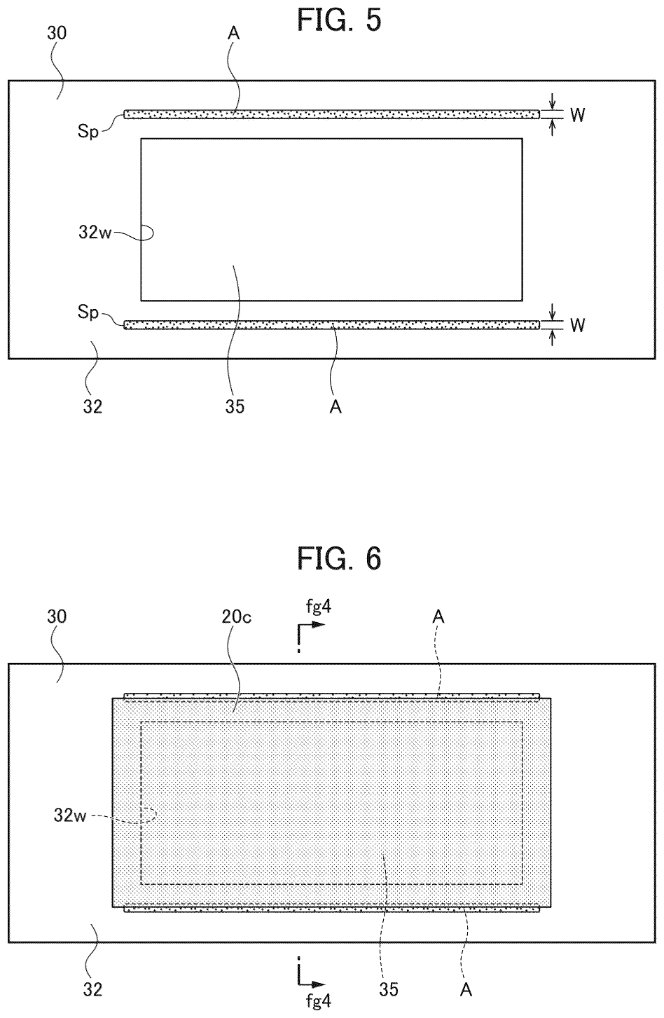

The intermediate layer 30 includes a resin film 32 and an electrolyte membrane 35. The resin film 32 is a film for protecting an edge portion of the electrolyte membrane 35, and is provided around the electrolyte membrane 35. Specifically, the resin film 32 includes, for example, two films which are a first resin film on an anode side with respect to the electrolyte membrane 35 and a second resin film on a cathode side with respect to the electrolyte membrane 35. As shown in FIG. 5, the resin film 32 is formed with a film window 32w through which a portion of the electrolyte membrane 35 other than the edge portion thereof is exposed.

As shown in FIG. 4, each gas diffusion layer 20a, 20c includes carbon paper 23 and a porous layer 26. The porous layer 26 is provided closer to the intermediate layer 30 with respect to the carbon paper 23.

As shown in FIG. 6, the intermediate layer 30 is slightly larger than the gas diffusion layers 20a, 20c in plan view. Thus, as shown in FIG. 4, an end portion of the intermediate layer 30 protrudes from between the gas diffusion layers 20a, 20c. The anode-side gas diffusion layer 20a is attached to the intermediate layer 30 by thermal pressing. On the other hand, the cathode-side gas diffusion layer 20c is attached to the intermediate layer 30 with an adhesive A.

Hereinafter, gas containing hydrogen will be referred to as “fuel gas”, and gas containing oxygen will be referred to as “oxidation gas”. Upon use of the fuel cell 40 shown in FIG. 4, electrodes on both sides of the intermediate layer 30, i.e., an anode-side electrode and a cathode-side electrode, are electrically connected to each other via a circuit including a power supply target. In this state, when the fuel gas is supplied to the anode-side gas diffusion layer 20a and the oxidation gas is supplied to the cathode-side gas diffusion layer 20c, power is generated.

The adhesive application system 50 shown in FIG. 1 is a system for applying the adhesive A to the cathode-side surface of the intermediate layer 30 at a stage of manufacturing the above-described fuel cell 40 shown in FIG. 4. Specifically, the adhesive application system 50 applies the adhesive A in the form of a solid line along the film window 32w to portions of the resin film 32 on both sides of the film window 32w, as shown in FIG. 5.

As shown in FIG. 1, the adhesive application system 50 includes an applier 51, a pressurization system 52, a robot arm 53, and a controller 55.

The applier 51 is, for example, a dispenser nozzle, and stores the adhesive A therein. The adhesive A is a moisture-curing adhesive. The pressurization system 52 is, for example, of an air pressure control type, and is capable of supplying a back pressure to the adhesive A in the applier 51. A valve 51b is provided between the pressurization system 52 and the applier 51. When the valve 51b is opened, the adhesive A is applied from the applier 51 by the back pressure from the pressurization system 52.

The robot arm 53 is capable of moving the applier 51. The controller 55 controls the pressurization system 52, the valve 51b, and the robot arm 53.

Next, problems to be solved in the present embodiment will be described. Hereinafter, a case where the controller 55 shown in FIG. 1 makes the following control will be referred to as a “comparative example”. In the comparative example, the valve 51b is opened in a state of the applier 51 being stopped at a position immediately above a predetermined application start point Sp, and when application of the adhesive A starts, the applier 51 is linearly moved. In this case, due to a delay in the start of movement of the applier 51 from the application start point Sp, a liquid accumulation Ap may be formed at the application start point Sp as shown in FIG. 2.

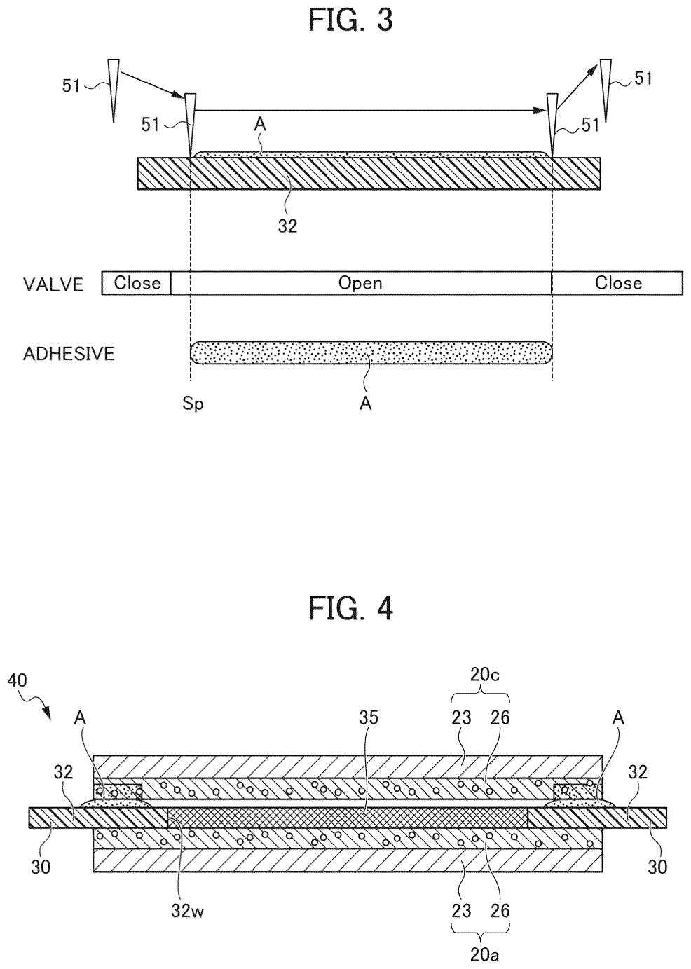

On this point, the controller 55 of the present embodiment shown in FIG. 1 opens the valve 51b before the applier 51 reaches the position immediately above the application start point Sp while moving the applier 51 shown in FIG. 3 by the robot arm 53. In this manner, the adhesive A is applied in the form of a solid line from the application start point Sp. Note that the timing of opening the valve 51b is controlled to the timing of the adhesive A being applied to the resin film 32 from the application start point Sp based on the viscosity of the adhesive A, the magnitude of the back pressure, and the movement speed of the applier 51. Thereafter, the controller 55 closes the valve 51b at predetermined timing, and then, application of the adhesive A is completed.

The above-described operation is performed twice for different locations to be applied with the adhesive A, and in this manner, the adhesive A is applied in the form of a solid line along the film window 32w to the portions of the resin film 32 on both sides of the film window 32w, as shown in FIG. 5. The resin film 32 is less likely to absorb moisture. Thus, the moisture-curing adhesive A applied to the upper surface of the resin film 32 is less likely to be cured. Note that manufacturing environment at this point is about 50% RH (23° C.).

Thereafter, the cathode-side gas diffusion layer 20c shown in FIG. 6 is stacked on the intermediate layer 30. Specifically, at this point, the porous layer 26 shown in FIG. 4 contacts the adhesive A. The porous layer 26 easily absorbs moisture, and therefore, contains sufficient moisture at this point. The adhesive A is easily cured with the moisture in the porous layer 26.

Hereinafter, the configuration and effects of the present embodiment will be summarized. Hereinafter, the cathode-side gas diffusion layer 20c will be merely referred to as a “gas diffusion layer 20c”.

According to the present embodiment, as shown in FIG. 3, the valve 51b is opened before the applier 51 reaches the position immediately above the application start point Sp while the applier 51 is moving. Thus, as compared to a case where the valve 51b is opened in a state of the applier 51 being stopped at the position immediately above the application start point Sp and the applier 51 is linearly moved when application of the adhesive A starts, i.e., as compared to the comparative example shown in FIG. 2, the liquid accumulation Ap at the application start point Sp can be reduced as shown in FIG. 3. Consequently, when the cathode-side gas diffusion layer 20c shown in FIG. 6 is bonded to the intermediate layer 30 shown in FIG. 5, spread of the adhesive A from a desired application region can be reduced. As a result, spread of the adhesive A to an adhesive inapplicable region of the fuel cell 40 can be reduced.

Specifically, the adhesive inapplicable region described here includes, for example, an electrode region and the vicinity of a seal region in the fuel cell 40 shown in FIG. 4. The electrode region is regions on both sides of the electrolyte membrane 35 in the thickness direction thereof. On the other hand, the seal region is a joint region between a plurality of cover members (not shown) that covers the intermediate layer 30 and the gas diffusion layers 20a, 20c. The vicinity of the seal region is thus the vicinity of the portion of the intermediate layer 30 protruding from between the gas diffusion layers 20a, 20c. Thus, upon application of the adhesive A, the electrode region and the vicinity of the seal region are located on each side with respect to the application region in the horizontal direction.

As described above, according to the present embodiment, the liquid accumulation Ap is reduced, and therefore, spread of the adhesive A to the electrode region and the vicinity of the seal region on each side can be reduced. Thus, a negative effect in which the adhesive A spreads to the electrode region and adversely influences, for example, the internal resistance of the fuel cell 40 and a negative effect in which the adhesive A spreads to the vicinity of the seal region and adversely influences the sealability of the fuel cell 40 can be reduced.

Since the liquid accumulation Ap can be reduced as described above, a variation in the amount of adhesive A, which is applied in the form of a solid line as shown in FIG. 6, permeating each portion of the gas diffusion layer 20c can be reduced. Thus, a variation in the elasticity of each portion of the gas diffusion layer 20c can also be reduced.

The adhesive A shown in FIG. 5 is the moisture-curing adhesive A. As described above, the resin film 32 is less likely to absorb moisture, and on the other hand, the porous layer 26 of the gas diffusion layer 20c easily absorbs moisture. Thus, the adhesive A is less likely to be cured at the point when the moisture-curing adhesive A is applied to the resin film 32 as shown in FIG. 5. Thereafter, the adhesive A is easily cured with the moisture in the gas diffusion layer 20c at the point when the gas diffusion layer 20c contacts the adhesive A as shown in FIG. 6. Thus, the gas diffusion layer 20c is easily properly bonded to the intermediate layer 30. Consequently, the total amount of adhesive A shown in FIG. 5 is easily reduced, and the width W of the applied adhesive A is easily reduced. As a result, when the gas diffusion layer 20c shown in FIG. 6 is bonded to the intermediate layer 30, spread of the adhesive A from the desired application region can be reduced.

### Second Embodiment

Next, a second embodiment will be described. Differences of the present embodiment from the first embodiment will be mainly described, and description of the same contents as or contents similar to those of the first embodiment will be omitted arbitrarily.

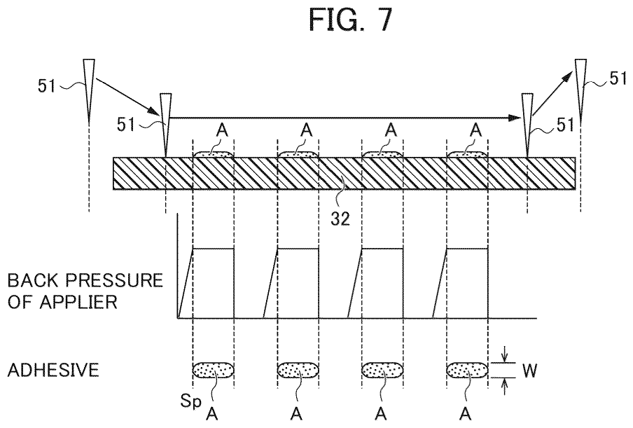

In the present embodiment, the controller 55 shown in FIG. 1 intermittently opens the valve 51b while moving the applier 51 by the robot arm 53. In this manner, as shown in FIG. 7, the back pressure from the pressurization system 52 is intermittently applied to the adhesive A in the applier 51. Accordingly, the adhesive A is applied in the form of a dashed line to the resin film 32.

According to the present embodiment, the following effects are obtained. In a case where the adhesive A is applied in the form of a solid line as shown in FIG. 5, there is a limitation on reduction in the application width W. On this point, according to the present embodiment, since the valve 51b is intermittently opened, the adhesive A is applied in the form of a dashed line as shown in FIG. 7. Thus, the width W of the applied adhesive A is easily reduced.

Consequently, when the gas diffusion layer 20c is bonded to the intermediate layer 30, spread of the adhesive A from the desired application region can be reduced.

### Other Embodiments

The embodiments described above may be changed as follows. In the second embodiment shown in FIG. 7, the valve 51b may be opened after movement of the applier 51 by the robot arm 53 has been temporarily stopped. Also in this case, an effect of easily reducing the application width W by applying the adhesive A in the form of a dashed line as compared to a case of applying the adhesive A in the form of a solid line is obtained.

### EXPLANATION OF REFERENCE NUMERALS

20c Cathode-Side Gas Diffusion Layer
30 Intermediate Layer
32 Resin Film
35 Electrolyte Membrane
40 Fuel cell
50 Adhesive Application System
51 Applier
51b Valve
53 Robot Arm
55 Controller
A Adhesive
Sp Application Start Point

What is claimed is:

1. An adhesive application system for applying an adhesive to an intermediate layer at a stage of manufacturing a fuel cell including the intermediate layer and gas diffusion layers on both sides thereof, comprising:
an applier that applies the adhesive when a valve is opened;
a robot arm capable of moving the applier; and
a controller that controls the valve and the robot arm,
wherein the controller opens the valve before the applier reaches a position immediately above an application start point while moving the applier by the robot arm, thereby applying the adhesive in a form of a line to the intermediate layer from the application start point.

2. The adhesive application system according to claim 1, wherein the controller intermittently opens the valve, thereby applying the adhesive in a form of a dashed line, which is a discontinuous form of the line, to the intermediate layer.

3. An adhesive application system for applying an adhesive to an intermediate layer at a stage of manufacturing a fuel cell including the intermediate layer and gas diffusion layers on both sides thereof, comprising:
an applier that applies the adhesive when a valve is opened;
a robot arm capable of moving the applier; and
a controller that controls the valve and the robot arm,
wherein the controller moves the applier by the robot arm and intermittently opens the valve, thereby applying the adhesive in a form of a dashed line to the intermediate layer.

4. The adhesive application system according to claim 1, wherein
the intermediate layer includes an electrolyte membrane and a resin film provided around the electrolyte membrane,
the adhesive is a moisture-curing adhesive, and
the controller applies the adhesive to the resin film.
